(19) United States
(12) Patent Application Publication
(10) Pub. No.: US 2020/0114426 A1
(43) Pub. Date: Apr. 16, 2020

(54) An Additive Manufacturing Method for Precipitation-Hardened Superalloy Powdered Material

(71) Applicant: Siemens Aktiengesellschaft, München (DE)

(72) Inventors: Dmitry Nesterenko, St. Petersburg (RU); Mikhail Ryazanov, Moskau (RU); Denis Saraev, Khimki (RU)

(21) Appl. No.: 16/624,712

(22) PCT Filed: Jun. 30, 2017
(86) PCT No.: PCT/RU2017/000474

§ 371 Date: Dec. 19, 2019

(51) Int. Cl. B22F 3/105; B22F 3/10; B33Y 10/00; B33Y 70/00

(52) U.S. Cl. CPC B22F 3/1055; B22F 3/1017; B22F 2301/15; B33Y 70/00; B22F 2003/1056; B33Y 10/00

(57) ABSTRACT

An additive manufacturing technique, wherein a first layer of powdered material is spread on a build platform, with or without a workpiece positioned therein, the build platform is in a part building module of an additive manufacturing apparatus, the powdered material is a precipitation-hardened superalloy such as a Nickel-based superalloy, for example, a Nickel-based superalloy having a percentage by volume of gamma prime phase equal to or greater than 45 percentage by volume, the first layer forms at least a part of a powder bed formed of the powdered material on the build platform, the powdered material of the first layer is heated to a temperature between 65 percent and 70 percent of a liquidus temperature of the precipitation-hardened superalloy and, after the aforementioned pre-heating, portions of a surface of the first layer are selectively scanned by using an energy beam arrangement to melt or sinter the selectively scanned portions.

### CROSS-REFERENCE TO RELATED APPLICATIONS

This is a U.S. national stage of application No. PCT/RU2017/000474 filed Jun. 30, 2017.

### BACKGROUND OF THE INVENTION

### 1. Field of the Invention

The present invention relates to additive manufacturing (AM) and, more particularly, to methods of additive manufacturing for precipitation-hardened superalloys.

### 2. Description of the Related Art

In recent times, additive manufacturing technologies are being extensively used for the manufacturing of high-end industrial components and medical implants. AM technology enables rapid manufacture and/or repair of components, and aid to achieve the fabrication of complex designs.

Additive Manufacturing (AM), also known as Additive Layer Manufacturing (ALM), 3D printing, rapid prototyping or freeform fabrication, is a group of processes of joining additive materials, i.e., plastic, metal or ceramic to make objects from 3D model data, usually building it up layer upon layer.

Additive manufacturing (AM) is a relatively new consolidation process that can produce a functional complex part, layer by layer, without moulds or dies. This process uses a powerful heat source, such as a laser beam, to melt a controlled amount of additive material, such as metals or alloys in the form of powder, which is then deposited, initially, on a building platform or a surface of a prefabricated workpiece. Subsequent layers are then built up upon each preceding layer or previously formed layer. As opposed to conventional machining processes, this computer-aided manufacturing (CAM) technology builds complete functional parts or, alternatively, builds features on existing components, i.e., on a workpiece, by adding material to the workpiece layer by layer rather than by removing it as is done in machining.

Additive manufacturing often starts by slicing a three dimensional representation, for example, a CAD model, of a part to be manufactured into very thin layers, thereby creating a two dimensional image of each layer. As aforementioned, the part to be manufactured can be a part that is to be built on a workpiece, for example, during the repair of a chipped turbine blade the chipped turbine blade is the workpiece and the patch formed to fill or reform the chipped part is the part that is built on the workpiece. The workpiece is positioned on a build platform. To form each layer, popular laser additive manufacturing techniques, such as selective laser melting (SLM) and selective laser sintering (SLS), involve mechanical pre-placement of a thin layer of powdered material of precise thickness on a surface of the workpiece and in adjoining horizontal surface above the build platform. Such pre-placement is achieved by using a mechanical wiper or by a powder spreading mechanism to sweep or spread a uniform layer of the powder or to screed the layer, after which an energy beam, such as a laser, is indexed across the powder layer according to the two dimensional pattern of solid material for the respective layer. After the indexing operation is complete for the respective layer, the build platform, and therefore the horizontal plane of deposited material, is lowered and the process is repeated until the three dimensional part is completely built on the workpiece as desired. In order to protect the thin layers of fine metal particles from contaminants and from moisture pickup, the operation is usually performed under an atmosphere of inert gas, such as argon.

Alternatively, when manufacturing the part from the beginning, no pre-placement of the workpiece on the build platform is required. A first layer of the part is manufactured by the additive manufacturing process in one of the layers, generally the first layer, of the powdered material spread on the build platform. Subsequent layers of the part are manufactured on top of the first layer of the part by the additive manufacturing process as aforementioned.

Nowadays, the AM processes are widely used in aerospace and energy industries, medical applications, jewelry, etc. Selective Laser Melting (SLM) and Selective Laser Sintering (SLS), as well as Direct metal laser sintering (DMLS), Direct metal laser melting (DMLM), are AM processes that use energy in the form of a high-power laser beam to create three-dimensional metal parts by fusing, or sintering in the case of SLS, fine particles of thin powder layer together.

A lot of parts that are desired to be built by the AM techniques are required to be built with powdered material that is a precipitation hardened superalloy. Precipitation hardening, also called Precipitation strengthening or age hardening, is a well known heat treatment technique used to increase the yield strength of malleable materials. Precipitation hardening is beneficially used to increase the yield strength of many structural alloys, for example, alloys of aluminium, magnesium, nickel, titanium, and some steels and stainless steels. A specific example of use of precipitation hardening is processing of superalloys, such as Nickel-based alloys (Ni-based alloys), which are extensively used for high-duty components of combustion engines and gas turbines due to their outstanding mechanical properties and corrosion/oxidation resistance at elevated temperatures. Additive manufacturing processes or techniques are often required in manufacturing and/or repair such components.

The superior mechanical properties of such precipitation-hardened or precipitation-strengthened material or alloys are attributed to the presence of secondary phase precipitates formed in the precipitation hardening or precipitation strengthening material or alloys as a result of precipitation hardening, for example, presence of gamma prime (γ′) phase in Ni-based superalloys that contributes to precipitation strengthening of the material. The higher the amount of gamma prime phase in the precipitation-hardened material or alloy, the higher the mechanical strength.

However, such precipitation-hardened material or superalloys comprising relatively high contents of secondary phase precipitates, such as gamma prime phase in Ni-based superalloys, are susceptible to cracking during additive manufacturing processes, particularly when the laser beam scans the precipitation-hardened superalloy powdered material, resulting in sintering or melting of the powdered material and subsequent solidification. During AM techniques, a highly localized heat input, e.g., laser or electron beam, leads to rapid melting and solidification of the precipitation-hardened superalloy powdered material, resulting in very large thermal gradients and solidification rates in the precipitation-hardened superalloy material. These thermal gradients cause high residual stresses or consequently micro/macro cracks form within the AM manufactured part, especially when precipitation-hardened Ni-based superalloys with a high γ′ phase fraction are concerned. The formation of cracks during the AM processes imposes serious limitations to the widespread use of the AM processes when using precipitation-hardened superalloy powdered material. As a result, such precipitation-hardened material or superalloys are difficult to manufacture by additive manufacturing techniques.

Therefore, there is a requirement for an AM technique, particularly AM methods, for fabricating or manufacturing parts using a precipitation-hardened superalloy powdered material with or without having a workpiece.

### SUMMARY OF THE INVENTION

In view of the foregoing, it is therefore an object of the present invention to provide an additive manufacturing technique, in particular additive manufacturing methods for manufacturing parts using a precipitation-hardened superalloy powdered material with or without having a workpiece.

This and other objects and advantages are achieved in accordance with the invention by additive manufacturing methods, where in a first embodiment of the present invention, in accordance with the additive manufacturing method, hereinafter also referred to as the AM method or simply to as the method, a first layer of powdered material is spread on a build platform. The build platform is in a part building module of an additive manufacturing apparatus. The powdered material is a precipitation-hardened superalloy, such as a Nickel-based superalloy, for example, a Nickel-based superalloy, having a percentage by volume of gamma prime phase equal to or greater than 45 percentage by volume. The first layer forms at least a part of a powder bed formed of the powdered material on the build platform. The powdered material of the first layer so spread on the build platform is heated such that a temperature of the powdered material of the first layer is between 65 percent and 70 percent of a the liquidus temperature of the precipitation-hardened superalloy. The aforementioned step of heating the first layer is also referred hereinafter to as the pre-heating. Finally in accordance with the method, portions of a surface of the first layer are selectively scanned by using an energy beam arrangement to melt or sinter the selectively scanned portions. Thus, in the present embodiment, the first layer, i.e., of the layer that is supposed to be selectively scanned to melt or sinter the selectively scanned portions of the layer, is pre-heated, i.e., heated before being selectively scanned and consequently melted or sintered.

The liquidus temperature specifies the lowest temperature at which the precipitation-hardened superalloy is completely melted.

The pre-heating of the first layer, i.e., of the layer that is supposed to be selectively scanned subsequently to melt or sinter the selectively scanned portions of the layer or of the layer that is exposed at a surface of the powder bed before being selectively scanned, within the aforementioned temperature range, i.e., between 65 percent and 70 percent of the liquidus temperature of the precipitation-hardened superalloy, decreases in the additive manufactured part induced residual stresses (maximum values) by a factor of approx. 5 to 10 when compared to a conventional additive manufacturing process without preheating of the exposed powder-bed layer. On the other hand, pre-heating of the layer to values above 70 percent of the liquidus temperature of the precipitation-hardened superalloy results in a much slower change in the calculated maximum residual stresses and increases the risk of liquation cracking during the additive manufacturing process in the part manufactured by additive manufacturing process. Therefore, the temperature range of heating of the layer before being selectively scanned, i.e., the preheating temperature range of 65 percent to 70 percent of the liquidus temperature of the precipitation-hardened superalloy results in a significant decrease in the level of residual tensile stresses and also reduces the risk of undesirable localized liquation during the additive manufacturing process. In addition, the proposed preheating temperatures mitigate the risk of sintering of the powdered material in the preheated powder bed, which would result in undesirably high surface roughness and imprecise geometry of the produced article. The sintering of metallic powder is known to be intensified with increasing temperature in the range T>0.7 Tₘ, where Tₘ is the melting (liquidus) temperature of material.

In an embodiment of the method of the first embodiment in accordance with the invention, after the melting or the sintering of the selective scanned portions of the surface of the first layer as aforementioned, the build platform along with a substrate and the powder bed are lowered to accommodate a second layer of the powdered material. The substrate includes a previously formed layer resulting from the aforementioned method, particularly from the melting or the sintering of the selective scanned portions of the surface of the first layer as aforementioned. Thereafter, the second layer of the powdered material is spread on the powder bed and a surface of the substrate. Subsequently, the powdered material of the second layer is heated to a temperature between 65 percent and 70 percent of the liquidus temperature of the precipitation-hardened superalloy. Finally, portions of the surface of the second layer of powdered material are selectively scanned by the energy beam arrangement to melt or sinter the selectively scanned portions onto the substrate. Thus, the pre-heating of the layer that is supposed to be selectively scanned to melt or sinter is applied to subsequently spread layers, i.e., to the layers that are spread after the first layer, and before these subsequently spread layers are selectively scanned. Therefore, the disclosed embodiments of the method are applicable to any or all of the layers that are spread and selectively scanned for manufacturing a part by additive manufacturing, and result in a significant decrease in the level of residual tensile stresses and in the risk of undesirable localized liquation during the additive manufacturing process for each such layer.

The aforementioned heating of the powdered material of the first layer and/or the second layer is performed by one of conductive heating by a heating element positioned underneath a surface of the build platform, infra-red heating by an Infra-red heater positioned above the first layer or the second layer, laser-beam heating by scanning the first layer or the second layer by an energy beam pre-heating arrangement before selectively scanning portions of the surface of the first layer or the second layer by the energy beam arrangement to melt or sinter the selectively scanned portions, and a combination thereof. The energy beam pre-heating arrangement for pre-heating the surface of the layers may be same as the energy beam arrangement for selectively scanning the surface of the layers to melt or sinter the selectively scanned portions of the surface. These provide some examples for pre-heating of the layers. Any other heating techniques may also be suitably used in accordance with the disclosed embodiments of the method.

In a second embodiment of the present invention, in another additive manufacturing method, hereinafter also referred to as the AM method or simply the method, a workpiece is positioned on a build platform. Generally, the workpiece is positioned on the build platform embedded in a bed of powdered material that is used to additively manufacture further layers on the workpiece. The build platform is in a part building module of an additive manufacturing apparatus. Thereafter, a first layer of powdered material is spread on the build platform, particularly on the bed of the powdered material in which the workpiece is embedded and on a surface of the workpiece positioned on the build platform. The powdered material is a precipitation-hardened superalloy, such as a Nickel-based superalloy, for example, a Nickel-based superalloy having a percentage by volume of gamma prime phase equal to or greater than 45 percentage by volume. The first layer forms at least a part of a powder bed formed of the powdered material on the build platform. The powdered material of the first layer so spread on the build platform is heated such that a temperature of the powdered material of the first layer is between 65 percent and 70 percent of a liquidus temperature of the precipitation-hardened superalloy. Finally, in accordance with the method, portions of a surface of the first layer are selectively scanned by using an energy beam arrangement to melt or sinter the selectively scanned portions onto the workpiece. Thus, the method is useful for additive manufacturing, where a workpiece is used and the part that is additively manufactured is fabricated on the workpiece. The method results in significant decrease in the level of residual tensile stresses and in the risk of undesirable localized liquation during the additive manufacturing process for the layer of the part that is fabricated on the workpiece.

In an embodiment of the method of the present invention in accordance with the second embodiment, after the melting or the sintering of the selective scanned portions of the surface of the first layer as aforementioned, the build platform along with a substrate and the powder bed are lowered to accommodate a second layer of the powdered material. The substrate includes the workpiece and a previously formed layer on the workpiece resulting from the aforementioned method, particularly from the melting or the sintering of the selective scanned portions of the surface of the first layer as aforementioned according to the second aspect. Thereafter, the second layer of the powdered material is spread on the powder bed and a surface of the substrate. Subsequently, the powdered material of the second layer is heated to a temperature between 65 percent and 70 percent of the liquidus temperature of the precipitation-hardened superalloy. Finally, portions of the surface of the second layer of powdered material are selectively scanned by the energy beam arrangement to melt or sinter the selectively scanned portions onto the substrate. Thus, the method in accordance with the disclosed embodiments is useful for additive manufacturing of subsequent layers of the part. The methods result in a significant decrease in the level of residual tensile stresses and in the risk of undesirable localized liquation during the additive manufacturing process for each such layer of the part that is fabricated on the workpiece.

The heating of the powdered material of the first layer and/or the second layer in accordance with the second embodiment is performed by one of conductive heating by a heating element positioned underneath a surface of the build platform, infra-red heating by an Infra-red heater positioned above the first layer or the second layer, laser-beam heating by scanning the first layer or the second layer by an energy beam pre-heating arrangement before selectively scanning portions of the surface of the first layer or the second layer by the energy beam arrangement to melt or sinter the selectively scanned portions onto the workpiece or onto the substrate as applicable, induction heating where the first layer or the second layer along with the workpiece or the substrate, respectively, is placed inside an Induction coil surrounding the first layer or the second layer and the workpiece or the substrate, and a combination thereof. The energy beam pre-heating arrangement for pre-heating the surface of the layers may be same as the energy beam arrangement for selectively scanning the surface of the layers to melt or sinter the selectively scanned portions of the surface. These provide some examples for pre-heating of the layers. Any other heating techniques may also be suitably used in the method.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention is further described hereinafter with reference to illustrated embodiments shown in the accompanying drawing, in which:

FIG. 1 schematically illustrates a top view of an exemplary embodiment of an additive manufacturing apparatus used for implementing methods of the present invention;

FIG. 2 schematically illustrates a side view of the additive manufacturing apparatus of FIG. 1;

FIG. 3 depicts a flow chart representing an additive manufacturing method in accordance with a first embodiment of the present invention;

FIG. 4 schematically illustrates an exemplary embodiment of a side view of the additive manufacturing apparatus representing a stage in the method of FIG. 3;

FIG. 5 schematically illustrates an exemplary embodiment of a side view of the additive manufacturing apparatus representing a stage of the method of FIG. 3 subsequent to the stage depicted in FIG. 4;

FIG. 6 depicts a flow chart representing an additive manufacturing method in accordance with a second embodiment of the present invention;

FIG. 7 schematically illustrates an exemplary embodiment of a side view of the additive manufacturing apparatus representing a stage in the method of FIG. 6;

FIG. 8 schematically illustrates an exemplary embodiment of a side view of the additive manufacturing apparatus representing a stage of the method of FIG. 6 subsequent to the stage depicted in FIG. 7;

FIG. 9 schematically illustrates an exemplary embodiment of a side view of the additive manufacturing apparatus having a heating element for direct conductive heating;

FIG. 10 schematically illustrates an exemplary embodiment of a side view of the additive manufacturing apparatus having an infra-red heater for infra-red heating;

FIG. 11 schematically illustrates an exemplary embodiment of a side view of the additive manufacturing apparatus having an energy beam pre-heating arrangement for laser-beam heating;

FIG. 12 schematically illustrates an exemplary embodiment of a side view of the additive manufacturing apparatus having an induction coil for induction heating;

FIG. 13 schematically illustrates an exemplary embodiment the induction coil of FIG. 12; and

FIG. 14 is a graphical plot of a pre-heating range in accordance with embodiments of the present invention.

### DETAILED DESCRIPTION OF THE EXEMPLARY EMBODIMENTS

Hereinafter, above-mentioned and other features of the present technique are described in details. Various embodiments are described with reference to the drawings, where like reference numerals are used to refer to like elements throughout. In the following description, for purposes of explanation, numerous specific details are set forth to provide a thorough understanding of one or more embodiments. It may be noted that the illustrated embodiments are intended to explain, and not to limit the invention. It may be evident that such embodiments may be practiced without these specific details.

It may be noted that in the present disclosure, the terms “first”, “second”, etc. are used herein only to facilitate discussion, and carry no particular temporal or chronological significance unless otherwise indicated.

The basic idea of the present invention is to heat a surface of a powder bed, i.e., to heat the surface of each layer, before the surface is selectively scanned to melt or sinter the precipitation-hardened superalloy, or in other words to pre-heat surface of each layer before selectively scanning the surface to melt or sinter the precipitation-hardened superalloy powder material to manufacture consecutive layers of the part that is being additively manufactured. The pre-heating for each layer of the precipitation-hardened superalloy powder material forming the surface of the powder bed is precisely maintained between 65 percent and 70 percent of a liquidus temperature of the precipitation-hardened superalloy.

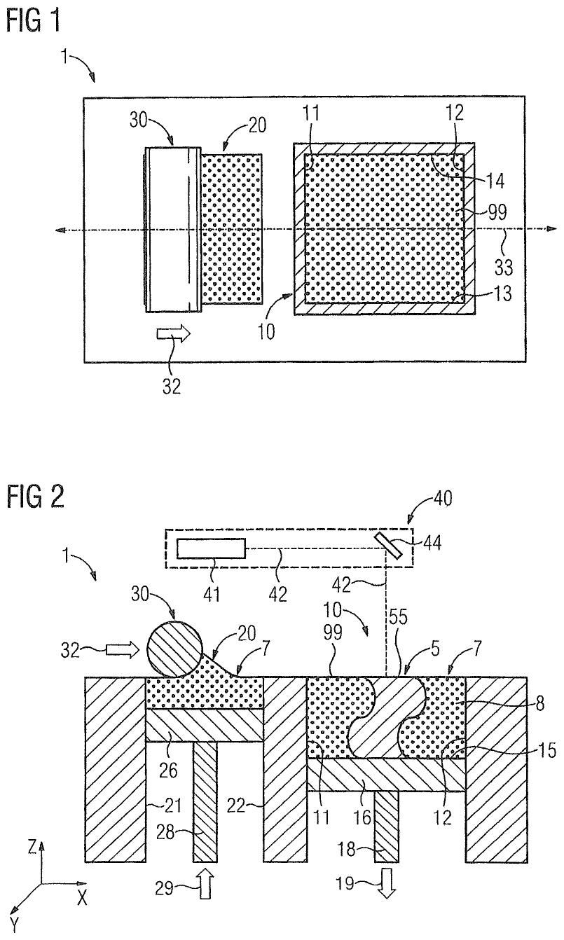

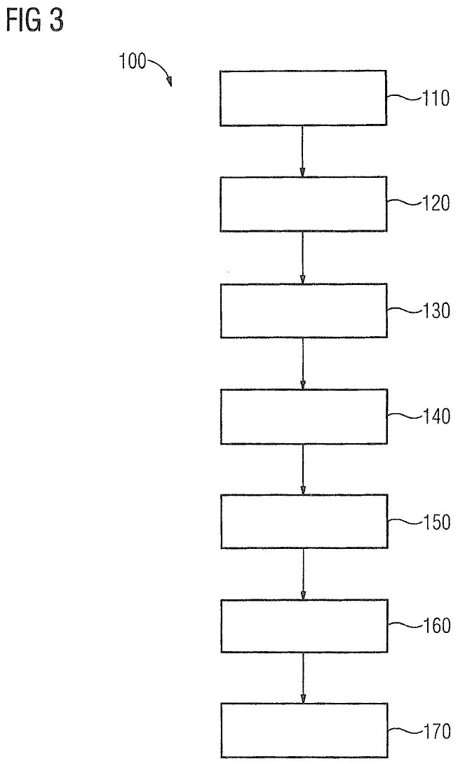

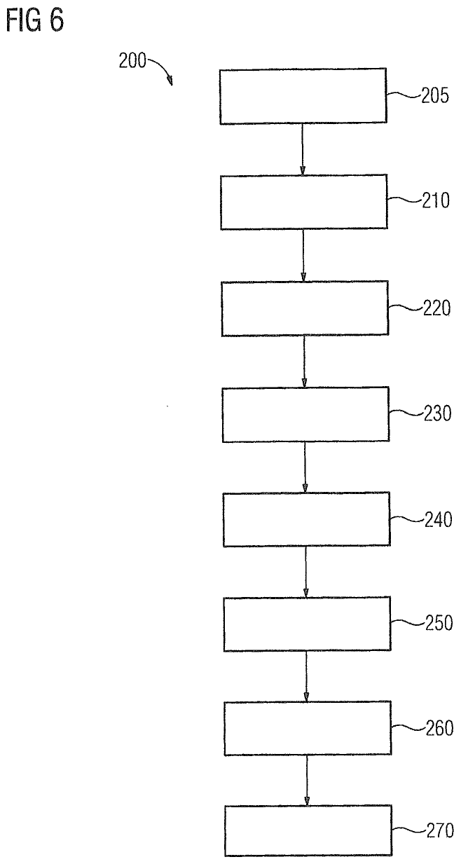

FIG. 3 is an illustration of a flow chart of an additive manufacturing method 100 for precipitation-hardened superalloy powder material, where a part is additively manufactured without a workpiece, whereas FIG. 6 is an illustration of a flow chart of an additive manufacturing method 200 for precipitation-hardened superalloy powder material, where a part is additively manufactured on a workpiece. Hereinafter, the additive manufacturing method 100 of FIG. 3 has also been referred to as the method 100 or the first method 100. Hereinafter, the additive manufacturing method 200 of FIG. 6 has also been referred to as the method 200 or the second method 200. FIG. 1 schematically illustrates a top view of an additive manufacturing apparatus 1 and FIG. 2 schematically illustrates a side view of the additive manufacturing apparatus 1 of FIG. 1 that may be used for implementing the method 100 and/or the method 200.

The additive manufacturing apparatus 1, hereinafter also referred to as the AM apparatus 1 or as the AM system 1 or simply as the apparatus 1, generally includes a part building module 10, also known as the build chamber 10, in which a part is built by additive manufacturing (AM), for example, by SLM or SLS processes. The part building module 10, hereinafter also referred to as the module 10, is a container for example a box shaped or barrel shaped container and having a top side of the container open. FIG. 2 represents such a container having side walls 11,12, 13,14 and a bottom surface 15. The side walls 11,12,13,14 and the bottom surface 15 together define a space in which the part is built by additive manufacturing. The part may be build with or without a prefabricated workpiece. When the part is built onto a workpiece 5, for example, as a part or integral addition to the workpiece 5, the space defined by the side walls 11,12,13,14 and the bottom surface 15 receives the workpiece 5. The workpiece 5 is an object that is supposed to be worked on by the AM apparatus 1 and built upon by addition of layer after layer by the AM method 200 by adding layer after layer of powdered material 7. The powder material 7 is provided by a powder storage module 20, also known as the feed cartridge 20, that stores the powdered material 7, hereinafter also referred to as the powder 7. The powder 7 in the feed cartridge 20 is stored in an open top container having side walls 21, 22 and a bottom 26. The bottom 26 is placed on top of a piston 28 that makes the bottom 26 slide or move in Z direction, as represented by the coordinate system shown in FIG. 2.

When the piston 28 moves upwards in the Z direction, i.e., in a direction 29, the powder 7 from the container 20 is raised above and outside the container 20. The powder 7 is then spread as top surface 99 of a bed 8 of the powder 7 in the module 10 by using a powder spreading mechanism 30, hereinafter also referred to as the spreading mechanism 30 or simply as the mechanism 30, which evenly spreads a thin layer of the powder 7 in the module 10. The layer is spread in a direction 32 shown in FIG. 2. Reference numeral 33 in FIG. 1 presents an axis along the direction 32. The opposing walls 11, 12 are generally perpendicularly disposed to the axis 33. Usually, the layer spread has a thickness of few micrometers, for example between 20 μm and 100 μm.

The module 10 or the build chamber 10 binds the bed 8 of powdered material 7, thus limiting the bed 8 by the side walls 11,12,13,14 and the bottom surface 15. The module 10 also includes a build platform 16. The bottom surface of the container of the module 10 is formed by the build platform 16, hereinafter also referred to as the platform 16. The platform 16 receives and supports the bed 8 of powdered material 7 and also the workpiece 5, if any, that is positioned on the platform 16 embedded within the bed 8. The platform 16 is placed on top of a piston 18 that makes the platform 16 slide or move in the Z direction, as represented by the co-ordinate system shown in FIG. 2.

When the piston 18 moves downward in the Z direction, i.e., in a direction 19, the bed 8, along with the workpiece 5, when present, is lowered thereby creating a space at surface 99 of the container of the module 10 to accommodate the layer that is spread subsequently by the spreading mechanism 30. The layer so spread by the spreading mechanism forms the surface 99 of the bed 8 and also covers a surface 55 of the workpiece 5 when present.

It may be noted that although in FIGS. 1 and 2 only one feed cartridge 20 and associated powder spreading mechanism 30 have been depicted, in most of the AM apparatus 1 there are generally two such feed cartridges 20 and associated powder spreading mechanisms 30, one on each side of the module 10, such as on side of the opposing walls 11 and 12.

The apparatus 1 also includes an energy beam arrangement 40. The energy beam arrangement 40 generally has an energy source 41 from which an energy beam 42, such as a Laser beam 42 or an electron beam 42, is generated, and a scanning mechanism 44 that directs the beam 42 to specific selected parts of the surface 99 of the powder bed 8 to melt or sinter the selectively scanned portions to form the layers of the part that is being additively manufactured. The specific portions of the surface 99 to which the beam 42 is directed are referred to as scanned. The selections of portions that are to be scanned by the beam 42 by action of scanning mechanism 44 are based on a 3D model, such as a CAD model, of the part that has to be built.

The build chamber 10, the feed cartridge 20, the spreading mechanism 30, and the energy beam arrangement 40 are well known in the art of additive manufacturing and thus not described herein in further details for the sake of brevity. The powdered material 7 used in the methods 100, 200 of the present invention is a precipitation-hardened superalloy, such as a Nickel-based superalloy, for example, a Nickel-based superalloy having a percentage by volume of gamma prime phase equal to or greater than 45 percentage by volume. An example of precipitation-hardened superalloy is a directionally solidified (DS) cast nickel-based superalloy material sold by Cannon-Muskegon Corporation under the designation CM-247 LC. CM-247 LC is known to have the following nominal composition, expressed as weight percentages: carbon 0.07%; chrome 8%; cobalt 9%; molybdenum 0.5%; tungsten 9.5%; tantalum 3.2%; titanium 0.7%; aluminum 5.6%; boron 0.015%; zirconium 0.01%; hafnium 1.4%; and the balance nickel. The aforementioned CM-247 LC is presented for exemplary purposes only and not by a way of limitation. It may be appreciated by one skilled in the art that any superalloy, and more particularly any Nickel based superalloy having gamma prime phase equal to or greater than 45 percentage by volume, may be used in the methods 100, 200 of the present invention. The article or the part that is made from the precipitation-hardened superalloy, hereinafter referred to as the superalloy, may be a component of a gas turbine, such as a blade or a vane of a gas turbine or any other components of a gas turbine, that are subjected to hot gas flow in the gas turbine, such as a heat shield. The present invention is used for additive manufacturing of such articles or parts.

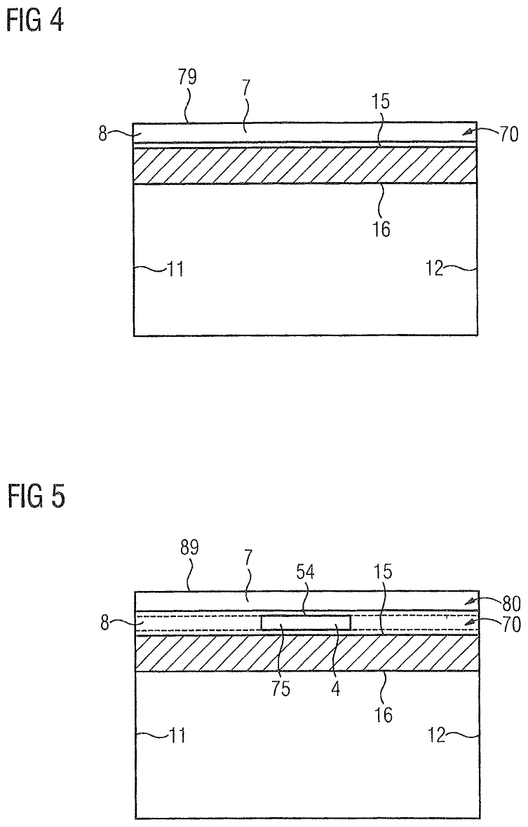

Hereinafter, the first method 100 of the present technique is explained with reference to FIG. 3 in combination with FIGS. 4 and 5 and FIG. 14. In the additive manufacturing method 100, i.e., the first method 100, in a step 110 a first layer 70 of powdered material 7 is spread on the build platform 16, as depicted schematically in FIG. 4. The first layer 70, hereinafter also referred to as the layer 70, is spread by using the spreading mechanism 30. As shown in FIG. 4, the layer 70 may be a first layer formed on the platform 16 and thus the bed 8 is formed only of the first layer 70 of powdered material 7. Alternatively, the layer 70 may be a first layer 70 formed on a pre-existing powder bed (not shown in FIG. 4). A top part of the layer 70 is a surface 79 that forms the surface 99 of the bed 8 of powdered material 7.

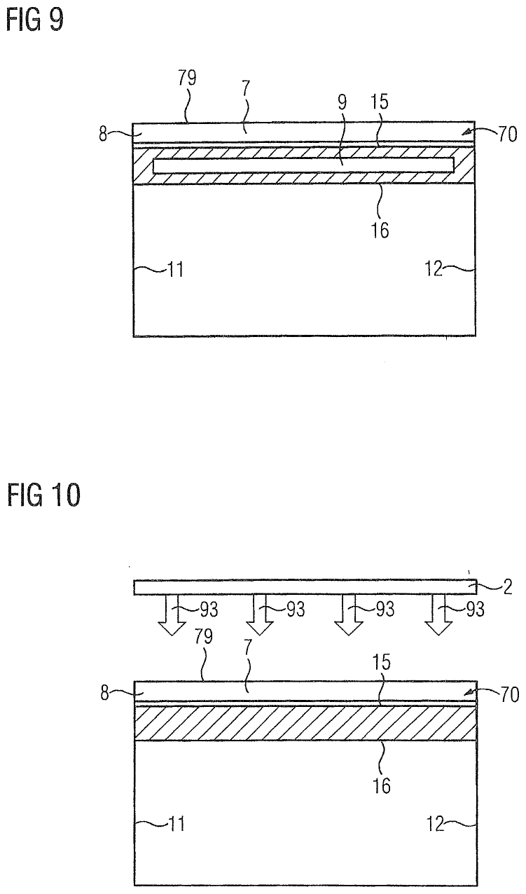

In a subsequent step 120 in the method 100, the powdered material 7 of the layer 70 spread on the build platform 16 is heated such that a temperature of the powdered material 7 of the layer is between 65 percent and 70 percent of a liquidus temperature of the precipitation-hardened superalloy. The heating 120 of the surface 79 may be performed by any suitable technique, some of which are depicted and explained later with reference to FIGS. 9 to 11.

Finally, in the AM method 100 as shown in FIG. 3, in a step 130 one or more portions of the surface 79 of the layer 70, i.e., the surface 99 of the powder bed 8, of powdered material 7 are selectively scanned by the energy beam arrangement 40 of the AM apparatus 1. As a result of the step 130, the powdered material 7 in the selectively scanned portions of the layer 70 is melted or sintered to form the part or portions or layers of the part or article being manufactured. The heating 120 of the powdered material 7 of the layer 70 spread on the build platform 16 is referred to as pre-heating of the powdered material 7 of the layer 70 because the heating 120 is performed before the selective scanning of the one or more portions of the surface 79 of the layer 70, i.e., of the surface 99 of the powder bed 8.

FIG. 14 represents a graphical plot having a curve 90 that shows the relationship between a pre-heating temperature and calculated residual stresses in the layers that are melted and sintered and thus manufactured by the additive manufacturing. In FIG. 14, the x-axis 91 represents the pre-heating temperature in degree Centigrade (OC) and the y-axis 92 represents maximal residual stresses in megapascal (MPa). The temperature range 97 is the range that represents 65 percent and 70 percent of the liquidus temperature of the precipitation-hardened superalloy, i.e., 0.65 Tₘ and 0.7 Tₘ, where Tₘ is the melting (liquidus) temperature.

Optionally, in addition to the aforementioned steps 110 to 130, the method 100 may be continued further as follows:

In a step 140, following the step 130, the platform 16 is lowered in the direction 19 (shown in FIG. 2) along with a substrate 4, i.e., portions or layer of the part formed as a result of the previously performed step 130, i.e., a previously formed layer 75 as shown in FIG. 5 and along the existing bed 8 of powdered material 7. As a result of the step 140, a space on top of the existing bed 8 is generated. The generated space is the same as the thickness of the next layer that is to be spread on the powder bed 8. Thereafter, a second layer 80 or a new layer 80 or another layer 80, as shown in FIG. 5, is spread in a step 150 by using the spreading mechanism 30 and the powder 7 provided by the feed cartridge 20. The space created in the step 140 accommodates the second layer 80 of powdered material 7, hereinafter also referred to as the layer 80. A surface 89 of the layer 80 now forms the surface 99 of the powder bed 8. As shown in FIG. 5, the layer 80 also spreads continuously over the previously formed layer 75, i.e., over the substrate 4. The substrate 4 at this stage has a surface 54, which includes a surface of the previously formed layer 75.

Subsequently, the powdered material 7 of the second layer 80 is heated in a step 160 to a temperature between 65 percent and 70 percent of the liquidus temperature of the precipitation-hardened superalloy powdered material 7. The heating 160 of the surface 89 may be performed by any suitable technique, some of which are depicted and subsequently explained with reference to FIGS. 9 to 13. Finally, in the method 100 as depicted in FIG. 3, in a step 170 portions of the surface 89 of the second layer 80 of powdered material 7, i.e., portions of the surface 99 of the powder bed 8 including the layer 80, are selectively scanned by the energy beam arrangement 40 to melt or sinter the selectively scanned portions onto the substrate 4.

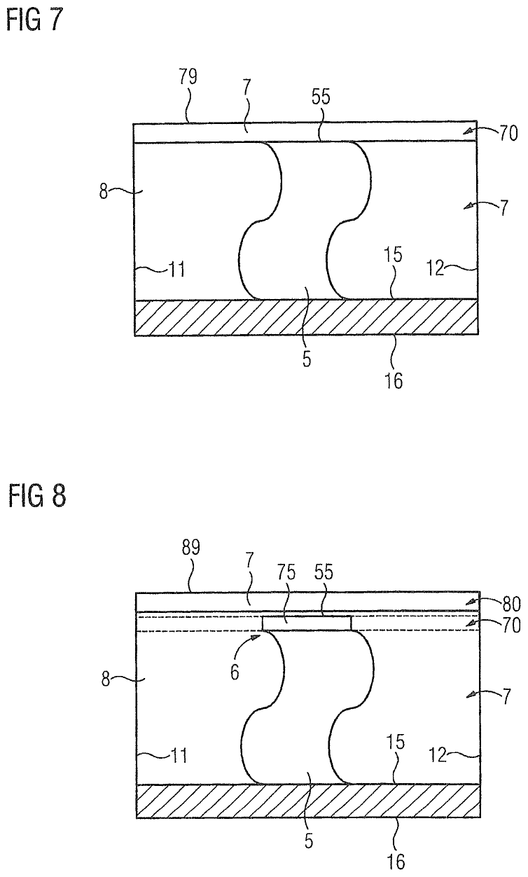

Hereinafter, the second method 200 of the present invention is explained with reference to FIG. 6 in combination with FIGS. 7 and 8 and FIG. 14. In the additive manufacturing method 200, i.e., the second method 200, in a step 205 a pre-formed or pre-fabricated workpiece 5 is positioned on the platform 16 as depicted in FIG. 7 and a first layer 70 of powdered material 7 is spread in a step 210 of the method 200. The workpiece 5 is generally embedded in a pre-existing powder bed 8 as shown in FIG. 7. Alternatively, the workpiece 5 may be embedded in the powder bed 8 by spreading 210 of the first layer 70 on the platform 16 by using the spreading mechanism 30. A top part of the first layer 70, hereinafter also referred to as the layer 70, forms the surface 99 of the powder bed 8. The layer 70 covers a surface 55 of the workpiece 5 as a result of the step 210 of the method 200.

In a subsequent step 220 in the method 200, the powdered material 7 of the layer 70 spread on the build platform 16 is heated such that a temperature of the powdered material 7 of the layer is between 65 percent and 70 percent of a liquidus temperature of the precipitation-hardened superalloy. The heating 220 of the surface 79 may be performed by any suitable technique, some of which are depicted and explained later with reference to FIGS. 9 to 13.

Finally, in the AM method 100 as shown in FIG. 6, in a step 230 one or more portions of the surface 79 of the layer 70, i.e., the surface 99 of the powder bed 8, of powdered material 7 are selectively scanned by the energy beam arrangement 40 of the AM apparatus 1. As a result of the step 230, the powdered material 7 in the selectively scanned portions of the layer 70 is melted or sintered to form the part or portions or layers of the part or article being manufactured on top of the workpiece 5. The heating 220 of the powdered material 7 of the layer 70 is referred to as pre-heating because the heating 220 is performed before the step 230. FIG. 14 in relation to FIG. 6 may be understood the same as the aforementioned explanation of FIG. 14 in reference to FIG. 3.

Optionally, in addition to the aforementioned steps 205 to 230, the method 200 may be continued further as follows:

In a step 240, following the step 230, the platform 16 is lowered in the direction 19 (shown in FIG. 2) along with a substrate 6. The substrate 6 includes the workpiece 5 and a previously formed layer 75 on the workpiece 5 resulting from the aforementioned method 200, particularly resulting from the steps 205 to 230 of the method 200 as aforementioned. Thereafter, in a step 250 the second layer 80 of the powdered material 7 is spread on the powder bed 8 and a surface 56 of the substrate 6 as shown in FIG. 8. Subsequently in the method 200, in a step 260 the powdered material 7 of the second layer 80 is heated to a temperature between 65 percent and 70 percent of the liquidus temperature of the precipitation-hardened superalloy powdered material. The heating 260 of the surface 89 may be performed by any suitable technique, some of which are depicted and explained later with reference to FIGS. 9 to 13. Finally, in the method 200, in a step 270 portions of the surface 89 of the second layer 80 of powdered material 7 are selectively scanned by the energy beam arrangement 40 to melt or sinter the selectively scanned portions onto the substrate 6.

Hereinafter, with reference to FIGS. 9 to 13 in combination with FIGS. 1 and 2, some exemplary techniques for the pre-heating of the powdered material 7 are provided, i.e., techniques to perform one or more of the step 120, the step 160, the step 220 and the step 260.

As depicted in FIG. 9, the additive manufacturing apparatus 1 may include a heating element 9 positioned underneath the surface 15 of the build platform 16. The heating element 9 may be embedded in the build platform 16 as depicted in FIG. 9 or alternatively may be present beneath the build platform 16. Preferably, the pre-heating, i.e., the heating in the steps 120, 160, 220 and 260 can be achieved by installing the heating element 9 embedded in or underneath the build platform 16. In this approach, the build platform 16, and the powder 7 on top of the build platform 16, i.e., the powder bed 8, are heated up by conductive heating to the temperature between 65 percent and 70 percent of the liquidus temperature of the precipitation-hardened superalloy powdered material 7 present on top of the build platform 16 at the surface 99 of the powder bed 8. In order to prevent the excessive heating of the surrounding structure, passive cooling, for example, use of insulation, as well as active cooling may be applied. The temperature of the build platform 16, and particularly of the surface 15 of the platform 16, and/or the surface 99 of the powder bed 8 may be constantly monitored, for example, by a thermocouple probe such that the pre-heating of the surface 99 of the bed 8, particularly of the surface 79, 89 of the layers 70,80 is between 65 percent and 70 percent of the liquidus temperature of the precipitation-hardened superalloy powdered material 7.

As depicted in FIG. 10, the additive manufacturing apparatus 1 may include an Infra-red heater 2 positioned above build platform 16, and particularly above the layers 70, 80 as applicable. The infra-red heater 2 emits infra-red 93 from a position over top of the build platform 16 as depicted in FIG. 10. Preferably, the pre-heating, i.e., the heating in the steps 120, 160, 220 and 260 can be achieved by installing the heating element 9 embedded in or underneath the build platform 16. In this approach, the surface 99 of the powder bed 8, and optionally the powder 7 in the feed cartridge 20, are heated up by infra-red heating to the temperature between 65 percent and 70 percent of the liquidus temperature of the precipitation-hardened superalloy powdered material 7 present at the surface 99 of the powder bed 8.

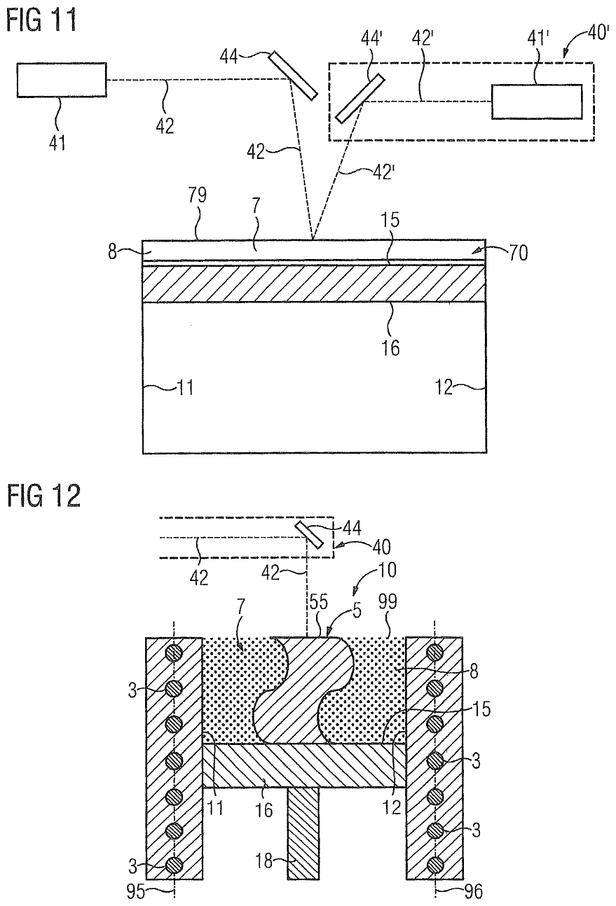

As depicted in FIG. 11, the additive manufacturing apparatus 1 may be equipped for laser-beam heating of the layers 70, 80 of the powder bed 8. The additive manufacturing apparatus 1 may include an energy beam pre-heating arrangement 40′, in addition to the energy beam arrangement 40 depicted in FIG. 2. The energy beam pre-heating arrangement 40′ generally has an energy source 41′ from which an energy beam 42′ or power beam 42′, such as a Laser beam 42′ or an electron beam 42′, is generated, and a scanning mechanism 44′ that directs the beam 42′ to specific selected parts of the surface 99 of the powder bed 8 to pre-heat portions of the surface 99 of the bed 8, i.e., to pre-heat portions of the surface 79,89 of the layers 70, 80 that are subsequently to be scanned by the energy beam arrangement 40 to be melted or sintered. The specific portions of the surface 99 to which the beam 42′ is directed by action of the scanning mechanism 44′ are based on the 3D model, for example, the CAD model, of the part that has to be built. The power of the beam 42′ is regulated or maintained or fixed such that selected portions of the surface 99 of the powder bed 8 are heated up by laser-beam heating to the temperature between 65 percent and 70 percent of the liquidus temperature of the precipitation-hardened superalloy powdered material 7.

Alternatively, the apparatus 1 may not include the energy beam pre-heating arrangement 40′, and in such apparatus 1 the energy beam arrangement 40 may function as the energy beam pre-heating arrangement 40′. Thus, selected portions of the surface 99 of the powder bed 8 are scanned in two stages, the pre-heating stage and the melting/sintering stage by the energy beam arrangement 40. In the pre-heating stage, i.e., the heating in the steps 120, 160, 220 and 260, the surface 99 of the powder bed 8 is heated up to the temperature between 65 percent and 70 percent of the liquidus temperature of the precipitation-hardened superalloy powdered material 7 present at the surface 99 of the powder bed 8.

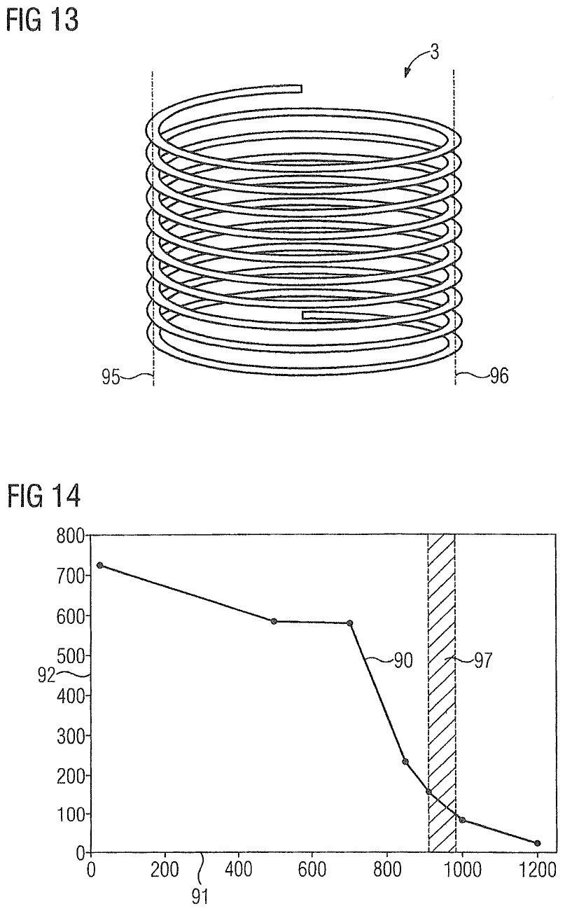

As depicted in FIGS. 12 and 13, the additive manufacturing apparatus 1 may include an induction coil 3 embedded in the walls 11,12,13,14 of the build chamber 10. As a result, when the workpiece 5 is positioned on the build platform 16 and/or the layers 70, 80 are spread on the build platform 16, the induction coil 3 surrounds the workpiece 5 and/or the layers 70, 80 and thus induction heating of the workpiece 5 and/or the layers 70, 80 is achieved. FIG. 13 shows the induction coil 3 when not embedded in the walls 11,12,13,14 of the build chamber 10, whereas FIG. 12 shows the induction coil 3 embedded in the walls 11,12,13,14 of the build chamber 10.

The cross-section of the induction coil 3 is visible in FIG. 12 along lines 95,96 schematically presented in FIG. 13. The inductive heating provides the pre-heating, i.e., the heating in the steps 120, 160, 220 and 260, of workpiece 5 and/or the layers 70, 80 to the temperature between 65 percent and 70 percent of the liquidus temperature of the precipitation-hardened superalloy powdered material 7 present at the surface 99 of the powder bed 8.

As aforementioned, besides the techniques for heating presented in FIGS. 9 to 13, other suitable techniques may also be used that can provide pre-heating of the surface 79, 89 of the layers 70, 80, i.e., of the surface 99 of the powder bed 8 to the temperature between 65 percent and 70 percent of the liquidus temperature of the precipitation-hardened superalloy 7 being used for fabricating the part or the article by the additive manufacturing methods 100,200.

While the present technique has been described in detail with reference to certain embodiments, it should be appreciated that the present technique is not limited to those precise embodiments. Rather, in view of the present disclosure which describes exemplary modes for practicing the invention, many modifications and variations would present themselves, to those skilled in the art without departing from the scope and spirit of this invention. The scope of the invention is, therefore, indicated by the following claims rather than by the foregoing description. All changes, modifications, and variations coming within the meaning and range of equivalency of the claims are to be considered within their scope.

1.-12. (canceled)

13. An additive manufacturing method comprising:
spreading a first layer of powdered material on a build platform of a part building module of an additive manufacturing apparatus, the powdered material comprising a precipitation-hardened superalloy and the first layer forming at least a part of a powder bed of the powdered material on the build platform;
heating the powdered material of the first layer spread on the build platform, a temperature to which the powdered material of the first layer is heated being between 65 percent and 70 percent of a liquidus temperature of the precipitation-hardened superalloy; and
selectively scanning, by an energy beam arrangement, portions of a surface of the first layer to melt or sinter the selectively scanned portions.

14. The additive manufacturing method according to claim 13, wherein the heating of the powdered material of the first layer is performed by at least one of (i) conductive heating by a heating element positioned underneath a surface of the build platform, (ii) infra-red heating by an Infra-red heater positioned above the first layer and (iii) laser-beam heating by scanning the first layer by an energy beam pre-heating arrangement before selectively scanning portions of the surface of the first layer to melt or sinter the selectively scanned portions.

15. The additive manufacturing method according to claim 13, further comprising:
lowering the build platform along with a substrate and the powder bed to accommodate a second layer of the powdered material, wherein the substrate comprises a previously formed layer resulting from the additive manufacturing method;
spreading the second layer of the powdered material on the powder bed and a surface of the substrate;
heating the powdered material of the second layer to a temperature between 65 percent and 70 percent of the liquidus temperature of the precipitation-hardened superalloy; and
selectively scanning, by the energy beam arrangement, portions of the surface of the second layer of powdered material to melt or sinter the selectively scanned portions onto the substrate.

16. The additive manufacturing method according to claim 14, further comprising:
lowering the build platform along with a substrate and the powder bed to accommodate a second layer of the powdered material, wherein the substrate comprises a previously formed layer resulting from the additive manufacturing method;
spreading the second layer of the powdered material on the powder bed and a surface of the substrate;
heating the powdered material of the second layer to a temperature between 65 percent and 70 percent of the liquidus temperature of the precipitation-hardened superalloy; and
selectively scanning, by the energy beam arrangement, portions of the surface of the second layer of powdered material to melt or sinter the selectively scanned portions onto the substrate.

17. The additive manufacturing method according to claim 15, wherein the heating of the powdered material of the second layer is performed by at least one of (i) conductive heating by a heating element positioned underneath a surface of the build platform, (ii) infra-red heating by an Infra-red heater positioned above the second layer and (iii) laser-beam heating by scanning the second layer of the powdered material by an energy beam pre-heating arrangement before selectively scanning portions of the surface of the second layer to melt or sinter the selectively scanned portions onto the substrate.

18. The additive manufacturing method according to claim 13, wherein the precipitation-hardened superalloy comprises a Nickel-based superalloy.

19. The additive manufacturing method according to claim 18, wherein the Nickel-based superalloy comprises a Nickel-based superalloy having a percentage by volume of gamma prime phase equal to or greater than 45 percentage by volume.

20. An additive manufacturing method comprising:
positioning a workpiece on a build platform of a part building module of an additive manufacturing apparatus;
spreading a first layer of powdered material on the build platform and a surface of the workpiece positioned on the build platform, the powdered material comprising a precipitation-hardened superalloy and the first layer forming at least a part of a powder bed of the powdered material on the build platform;
heating the powdered material of the first layer spread on the build platform and the surface of the workpiece, a temperature to which the powdered material of the first layer is heated being between 65 percent and 70 percent of a liquidus temperature of the precipitation-hardened superalloy; and
selectively scanning, by an energy beam arrangement, portions of a surface of the first layer to melt or sinter the selectively scanned portions onto the workpiece.

21. The additive manufacturing method according to claim 20, wherein the heating of the powdered material of the first layer is performed by at least one of (i) conductive heating by a heating element positioned underneath a surface of the build platform, (ii) infra-red heating by an Infra-red heater positioned above the first layer, (iii) laser-beam heating by scanning the first layer by an energy beam pre-heating arrangement before selectively scanning portions of the surface of the first layer to melt or sinter the selectively scanned portions onto the workpiece and (iv) induction heating in which the first layer along with the workpiece is placed inside an Induction coil surrounding the first layer and the workpiece placed therein.

22. The additive manufacturing method according to claim 20, further comprising:
lowering the build platform along with a substrate and the powder bed to accommodate a second layer of the powdered material, the substrate comprising the workpiece and a previously formed layer formed on the workpiece resulting from the additive manufacturing method;
spreading the second layer of the powdered material on the powder bed and a surface of the substrate;
heating the powdered material of the second layer to a temperature between 65 percent and 70 percent of the liquidus temperature of the precipitation-hardened superalloy; and
selectively scanning, by the energy beam arrangement, portions of the surface of the second layer of powdered material to melt or sinter the selectively scanned portions onto the substrate.

23. The additive manufacturing method according to claim 21, further comprising:
lowering the build platform along with a substrate and the powder bed to accommodate a second layer of the powdered material, the substrate comprising the workpiece and a previously formed layer formed on the workpiece resulting from the additive manufacturing method;
spreading the second layer of the powdered material on the powder bed and a surface of the substrate;
heating the powdered material of the second layer to a temperature between 65 percent and 70 percent of the liquidus temperature of the precipitation-hardened superalloy; and
selectively scanning, by the energy beam arrangement, portions of the surface of the second layer of powdered material to melt or sinter the selectively scanned portions onto the substrate.

24. The additive manufacturing method according to claim 22, wherein the heating of the powdered material of the second layer is performed by at least one of (i) conductive heating by a heating element positioned underneath a surface of the build platform, (ii) infra-red heating by an Infra-red heater positioned above the second layer, (iii) laser-beam heating by scanning the second layer of the powdered material by an energy beam pre-heating arrangement before selectively scanning portions of the surface of the second layer to melt or sinter the selectively scanned portions onto the substrate and (iii) induction heating wherein the second layer along with the substrate is placed inside an Induction coil surrounding the second layer and the substrate.

25. The additive manufacturing method according to claim 20, wherein the precipitation-hardened superalloy is a Nickel-based superalloy.

26. The additive manufacturing method according to claim 25, wherein the Nickel-based superalloy is a Nickel-based superalloy having a percentage by volume of gamma prime phase equal to or greater than 45 percentage by volume.
